(19) United States
(12) Patent Application Publication
(10) Pub. No.: US 2021/0289948 A1
(43) Pub. Date: Sep. 23, 2021

(54) HEALTH MATTRESS FOR HOME USE OR MEDICAL USE

(71) Applicant: Pungwoo OH, Seoul (KR)

(72) Inventors: Pungwoo OH, Seoul (KR); Shinyoung OH, Seoul (KR)

(21) Appl. No.: 17/262,182

(22) PCT Filed: Aug. 13, 2019
(86) PCT No.: PCT/KR2019/010263

§ 371 Date: Jan. 21, 2021

(30) Foreign Application Priority Data
Sep. 4, 2018 (KR) 10-2018-0105165

(51) Int. Cl. A47C 27/00; A47G 9/06; A47C 17/86; A61G 7/05; B32B 7/12; B32B 5/02; B32B 7/06

(52) U.S. Cl. CPC A47C 27/002; A47G 9/062; A47C 17/86; B32B 7/06; B32B 7/12; B32B 5/02; A61G 7/05

(57) ABSTRACT

A health mattress for home use or medical use is disclosed. The health mattress comprises: a lower cover integrally having a first edge part and a mounting part, which comes in contact with the human body, an upper cover integrally having a second edge part and a mesh part, which allows contaminants to pass there through, and separably coupled to the lower cover by a separable attachment structure between the first edge part and the second edge part; and a contaminant adhesion part interposed between the mesh part and the mounting part in a state in which the loser cover and the upper cover are coupled, and having one or more adhesive sheets to which contaminants having passed through the mesh part are adhered, wherein the mesh part comprises: a first mesh fabric and a second mesh fabric facing each other while being coupled to the inner periphery of a third edge part; and elastic yarn springs interposed between the first mesh fabric and the second mesh fabric so as to form a gap elastically expanding or contracting between the first mesh fabric and the second mesh fabric.

### FIELD OF INVENTION

The present invention relates to a health mattress for household or medical use, and specifically, to a health mattress used in homes or hospitals, which is generally placed on a bed, the floor of a floor-heated room, a sofa, a chair, etc. and on which a person sits or lies down. More particularly, the present invention relates to a health mattress for household or medical use, with functions to trap diverse fine dusts and/or other contaminants (cookie crumbs, medicine powder, hair dust, etc.).

### BACKGROUND OF INVENTION

A patient under long term medical treatment or recuperation in a hospital, sanatorium or even at home cannot have an active life for a long period of time but ought to lie in a bed or on the floor of a floor-heated room and be attended by a nurse. Since the patient under long term medical treatment or recuperation generally has been in the bed for a long period of time, they are inevitably susceptible to diseases such as bedsores (or abscess on the back of the patient). Further, such a long-term patient is also inevitably susceptible to a variety of respiratory diseases due to various fine dusts floating in the air or generated when a nurse wipes or brushes away dust from a coverlet or quilt.

In order to reduce diseases including bedsores, a mattress may be fabricated using only a material with high ventilating property. However, in this case, it is difficult for the mattress to possess cushioning power. Further, conventional household or medical mattresses may adversely affect patient health due to contaminants such as fine dust or cookie crumbs not easily removed from the mattress. Further, occurrence of diseases such as bedsores may be reduced or suppressed only by supplying fresh air to the back of a patient in the bed. However, a cushioning power-ensuring material and another material covering the same may inhibit smooth air circulation. Accordingly, there is a need for development of a new concept of mattress to solve problems of existing health mattresses for household or medical use.

### SUMMARY OF INVENTION

### Technical Problem to be Solved

Therefore, in order to overcome the aforementioned problems, an object of the present disclosure is to provide a health mattress for household or medical use that has sufficient cushioning power, can supply fresh and cool air to a body part of a patient in contact with the mattress when the patient sits or lies on the mattress, is very advantageous in trapping and removing various floating contaminants including fine dust so as to prevent the floating contaminants from entering a respiratory organ of the patient, thereby preventing respiratory disease.

### Technical Solution

Therefore, according to one aspect of the present invention, the health mattress for household or medical use may include: a lower cover integrally having a first edge part and a seating member which comes in contact with a human body; an upper cover integrally having a second edge part and a mesh part which allows contaminants to pass through the same, wherein the upper cover is removably coupled to the lower cover by a separable attachment structure between the first edge part and the second edge part; and a contaminant adhesion member interposed between the mesh part and the seating member in a state in which the lower cover and the upper cover are coupled, wherein the contaminant adhesion member has one or more adhesive sheets to which the contaminants having passed through the mesh part are adhered, and wherein the mesh part includes: a first mesh fabric and a second mesh fabric facing each other while being coupled to an inner periphery of a third edge part; and an elastic yarn spring interposed between the first mesh fabric and the second mesh fabric, so as to form a gap elastically expanding or contracting between the first mesh fabric and the second mesh fabric.

According to one embodiment, the contaminant adhesion member may include: a plurality of adhesive sheets, each having sticky surfaces on opposite sides thereof; an intermediate peel-off sheet interposed between upper and lower adjacent adhesive sheets; and a top peel-off sheet temporarily attached to a top surface of the uppermost adhesive sheet among the plural adhesive sheets, wherein the lowermost adhesive sheet among the plural adhesive sheets is adhered to a top surface of the seating member.

According to one embodiment, the lower cover may further include a plurality of viscoelastic bosses formed on a bottom of the seating member and coming into close contact with a bed, a sofa or the floor of a floor-heated room (hereinafter, “heated floor”)

According to one embodiment, a part of the intermediate peel-off sheet or the top peel-off sheet may further expand out of the edge of the adhesive sheet.

### Effect of Invention

As described above, the health mattress for household or medical use according to the present invention may have sufficient cushioning power, can supply fresh and cool air to a body part of a patient in contact with the mattress when the patient has a seat on the mattress, and is very advantageous in trapping and removing various floating contaminants including fine dust so as to prevent the floating contaminants from entering a respiratory organ of the patient, thereby preventing respiratory disease. Further, the mattress of the present invention can be easily cleaned by water-washing or spraying, and has advantages of excellent trapping ability of fine dust and other floating contaminants (medicine powder, hair, dust, crumbs, etc.) and enabling simple removal of the trapped contaminants, and semi-permanent usability.

### BRIEF DESCRIPTION OF DRAWINGS

FIG. 1 is a top perspective view illustrating the health mattress for household or medical use according to one embodiment of the present invention.

FIG. 2 is a bottom perspective view illustrating the health mattress for household or medical use according to one embodiment of the present invention.

FIG. 3 is an exploded perspective view illustrating the health mattress for household or medical use according to one embodiment of the present invention.

FIG. 4 is a cross-sectional view illustrating the health mattress for household or medical use according to one embodiment of the present invention.

FIG. 5 is a perspective view illustrating mesh fabric used for fabrication of the mattress shown in FIGS. 1 to 4.

FIG. 6 is an enlarged cross-sectional view illustrating “A” of FIG. 4.

FIGS. 7, 8 and 9 illustrate a method of using the health mattress for household or medical use according to one embodiment of the present invention.

### BEST MODE

Hereinafter, preferred embodiments of the present invention will be described in detail with reference to the accompanying drawings.

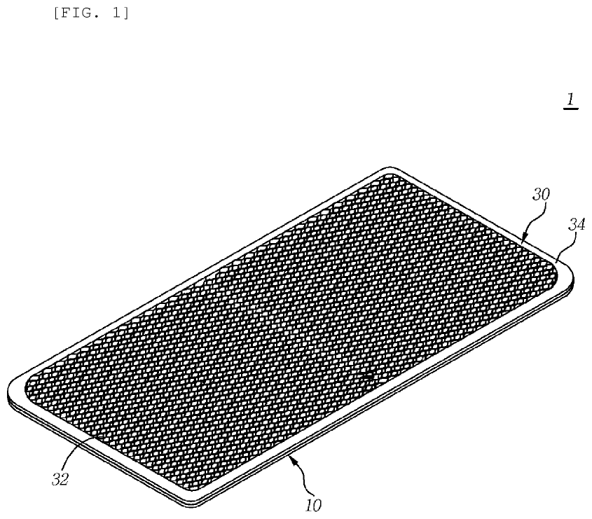

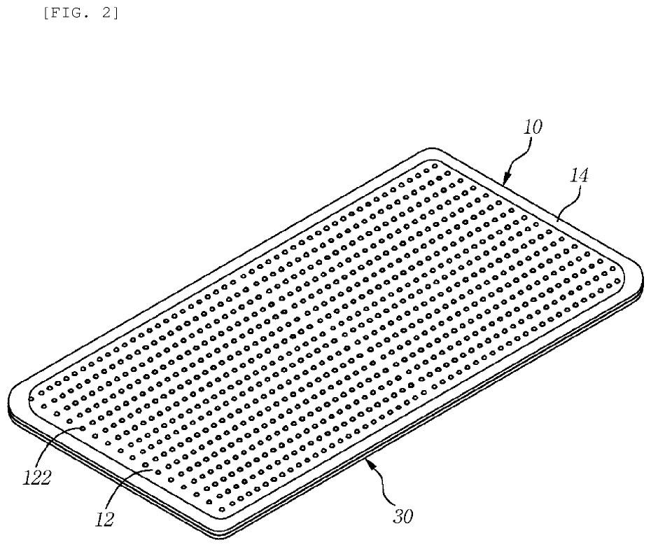

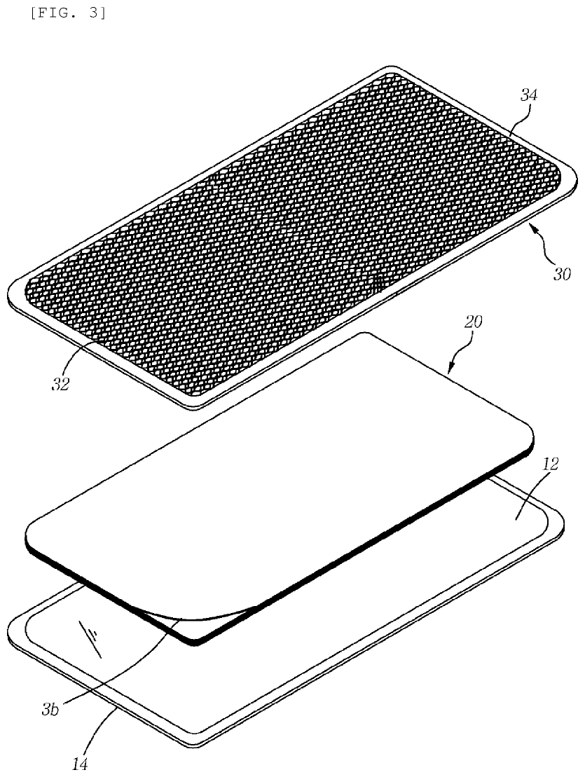

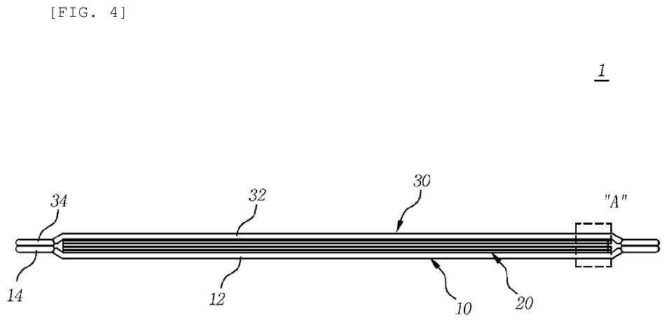

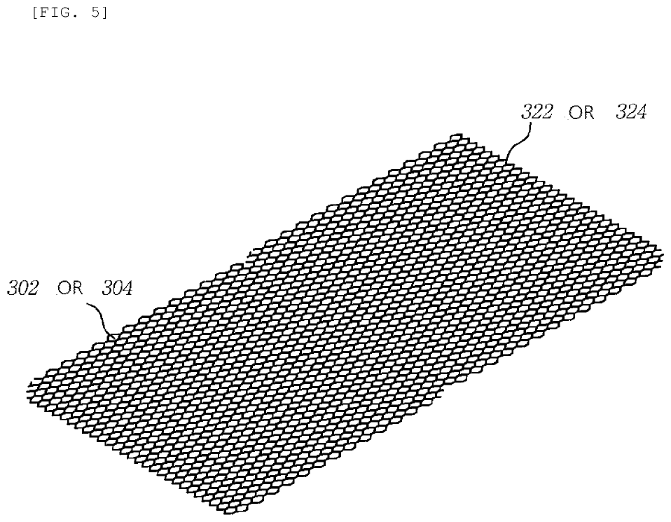

Referring to FIGS. 1 to 9, the health mattress for household or medical use according to one embodiment of the present invention is a health mattress to be used by spreading the same on a bed, a sofa and/or a heated floor, which includes a lower cover 10, an upper cover 30, and a contaminant adhesion member 20 interposed between the lower cover 10 and the upper cover 30.

The health mattress for household or medical use according to the present invention may be manufactured with a shape or size corresponding to that of a bed, sofa or chair. Further, in order to directly use the mattress on a heated floor or spread the same over bedclothes or a chair with different shapes or sizes to be used, the mattress may be fabricated with a variety of shapes or dimensions to be used. Further, a purchaser (or consumer) may select and purchase a mattress having a desired shape or size. Further, such mattress may be purchased at low price and used by a number of consumers. Moreover, the mattress of the present invention may be manufactured in diverse shapes and designs such as a rectangular, elliptical or triangular shape, or the like.

Meanwhile, the lower cover 10 may include: a seating member 12 typically formed in a rectangular form to be in contact with a bed, sofa or heated floor; and a first edge part 14 in the form of a rectangular ring coupled along the periphery of the seating member 12, opposite of these parts being integrated with each other. The seating member 12 and the first edge part 14 may be coupled by sewing, but the scope of the present invention is not particularly limited thereto. A bottom of the seating member 12 may be made of entirely closed fabric material. In addition, the bottom of the seating member 12 may be provided with a plurality of viscoelastic bosses 122 to ensure that the lower cover 10 remains in close contact with a bed, sofa or heated floor without slipping. The viscoelastic bosses 122 are preferably formed using a silicone resin having viscoelasticity. That is, the viscoelastic bosses 122 may come into close contact with the bed, sofa or heated floor, thereby preventing the mattress from being pushed out due to motion of a user.

Further, the upper cover 30 may include: a mesh part 32 typically formed in a rectangular form to pass fine dust and other floating contaminants there through; and a second edge part 34 in the form of a rectangular shape to be coupled along the periphery of the mesh part 32, opposite of these parts being integrated with each other. The mesh part 32 and the second edge part 34 may be coupled by sewing, but the scope of the present invention is not particularly limited thereto.

The first edge part 14 of the lower cover 10 and the second edge part 34 of the upper cover 30 may correspond to each other, and may be provided with a separable attachment structure such as Velcro tape. Due to the attachment structure of the first edge part 14 and the second edge part 34, if the first edge part 14 and the second edge part 34 are attached to each other, the lower cover 10 and the upper cover 30 may be removably coupled in a state wherein the seating member 12 and the mesh part 32 are separated from each other. Further, as the lower cover 10 and the upper cover 30 are removably coupled to each other, a contaminant adhesion member 20 may be interposed between the seating member 12 and the mesh part 32.

The mesh part 32 may include: a first mesh fabric 332 and a second mesh fabric 324 facing each other up and down while being coupled to an inner periphery of the second edge part 34; and an elastic yarn spring 36 interposed between the first mesh fabric 322 and the second mesh fabric 324 to form a gap elastically expanding or contracting between the first mesh fabric 322 and the second mesh fabric 324, these parts being integrated with one another.

Each of the first mesh fabric 322 and the second mesh fabric 324 may be fabricated in a net form using textile yarns to have holes 302 or 304 in an elliptical, parallelgrammic, rectangular, circular or polygonal shape to pass contaminants there through. Further, the mesh part 30 is a portion on which a human body is placed, and may have sufficient cushioning power ensured by the elastic yarn spring 36. The elastic yarn spring 36 may include a plurality of resin elastic yarns, opposite ends of each yarn being coupled to the first mesh fabric 322 and the second mesh fabric 324, respectively, wherein these resin elastic yarns can form a gap elastically compressed between the first mesh fabric 322 and the second mesh fabric 324. Further, the elastic yarn spring 36 may also participate in preventing the contaminants drained down from drifting again and escaping. On the other hand, the upper cover 30 may have a cushioning structure along with the elastic yarn spring 36 so as to provide comfort to a user.

Meanwhile, the contaminant adhesion member 20 may be interposed between the mesh part 32 and the seating member 12 in a state in which the lower cover 10 and the upper cover 30 are coupled to each other, and may further include a plurality of adhesive sheets 21, 22, 23, 24 and 25 to which the contaminants passing through the mesh part 32 are adhered. In this case, the adhesive sheet used herein may be prepared by coating opposite sides of a coating resin sheet with an adhesive material to which contaminants can be adhered.

Further, as described above, the contaminant adhesion member 20 includes plural adhesive sheets 21, 22, 23, 24 and 25, each having sticky surfaces on opposite sides thereof, and further includes intermediate peel-off sheets 3a interposed between upper and lower adhesive sheets 21 and 22, 22 and 23, or 24 and 25, respectively, as well as a top peel-off sheet 3b temporarily attached to a top surface of the uppermost adhesive sheet 25 among the above adhesive sheets 21, 22, 23, 24 and 25. In addition, the lowermost adhesive sheet among the plural adhesive sheets 21, 22, 23, 24 and 25 is adhered to a top surface of the seating member 12.

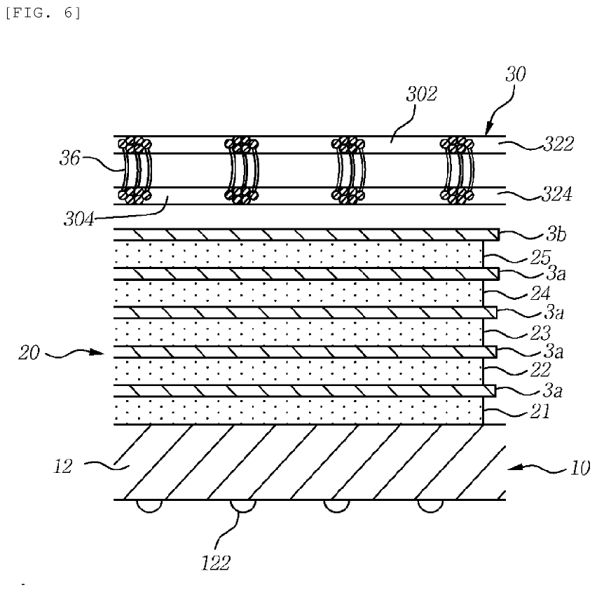

Prior to use of the mattress described above, the contaminant adhesion member 20 provided with the adhesive sheets 21, 22, 23, 24 and 25 as well as the peel-off sheets 3a and 3b is interposed between the lower cover 10 and the upper cover 30, wherein the lowermost adhesive sheet 21 in the contaminant adhesion member 20 is adhered to the top surface of the seating member 12. Such a state as described above is most concretely illustrated in FIG. 6. Further, as very clearly illustrated in FIG. 6, each intermediate peel-off sheet 3a or the top peel-off sheet 3b may have a larger area than those of the adhesive sheets 21, 22, 23, 24 and 24, thereby partially expanding out of the edge of the adhesive sheet 21, 22, 23, 24 or 25.

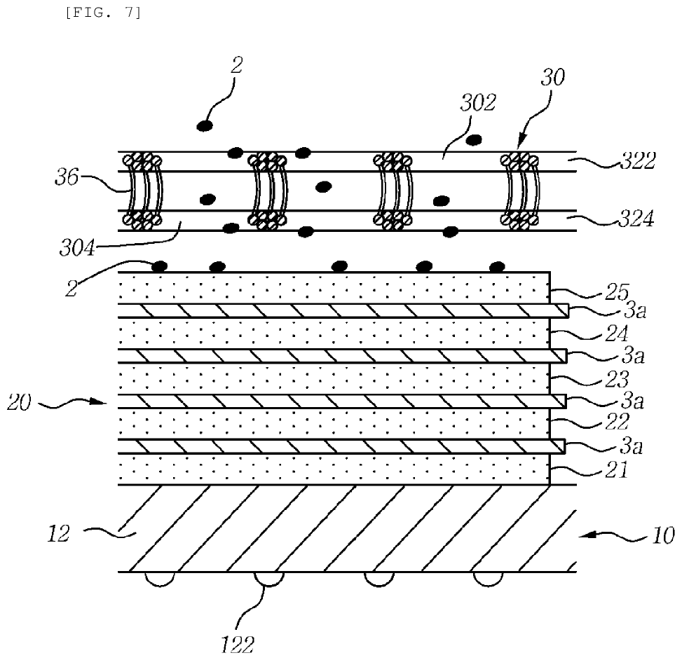

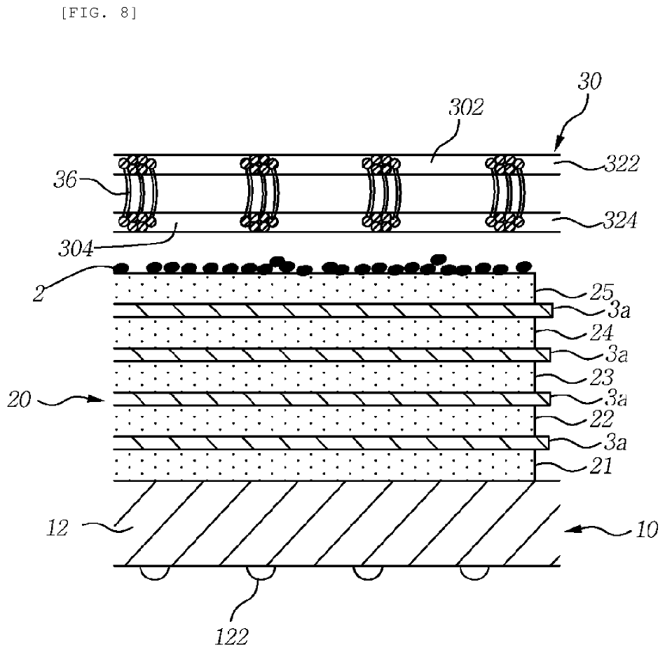

In order to use the aforementioned mattress, in a state in which the lower cover 10 and the upper cover 30 are separated, the top peel-off sheet 3b temporarily attached to the uppermost surface of the contaminant adhesion sheet 20, that is, a top sticky surface of the uppermost adhesive sheet 25 among the plural adhesive sheets 21, 22, 23, 24 and 25 should be removed, followed by coupling the lower cover 10 to the upper cover 30. The mattress prepared as such is placed on a sofa, bed or heated floor and used as shown in FIGS. 7 and 8.

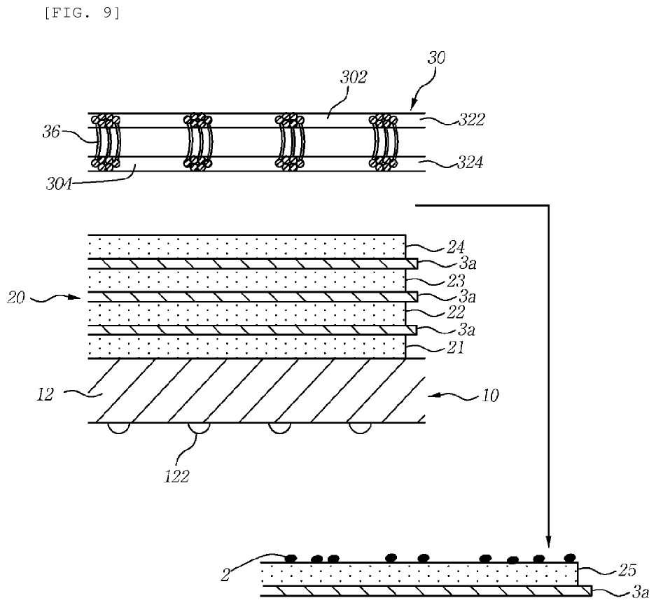

Referring to FIGS. 7 and 8, contaminants 2 pass through the holes 302 and 304 formed in the first mesh fabric 322 and the second mesh fabric 324 of the mesh part 30, and then are adhered to the uppermost surface of the contaminant adhesion member 20, that is, the top sticky surface of the uppermost adhesive sheet 25 among the plural adhesive sheets 21, 22, 23, 24 and 25. If the contaminants 2 accumulate on the uppermost adhesive sheet 25 to a level more than a permeable amount (or an acceptable limit) and cannot maintain desirably adhesive ability any more, the uppermost adhesive sheet 25 and the intermediated peel-off sheet 3a disposed there below should be removed as shown in FIG. 9, thereby exposing a top sticky surface of the next adhesive sheet 24 arranged under the above adhesive sheet 25.

When the intermediate peel-off sheet 3a is removed from the sticky surface of the next adhesive sheet 24, the uppermost adhesive sheet 25 adhered to a top surface of the intermediate peel-off sheet 3a is also separated simultaneously. Whenever the adhesive sheet exposed upward losses adhesive ability, the adhesive sheet having deteriorated adhesive ability and the intermediate peel-off sheet are repeatedly removed. When even the lowermost adhesive sheet 21 is exhausted (that is, end of lifespan), a new contaminant adhesion member may be attached again to a top surface of the seating member 12 in the lower cover 10 so as to be used.

According to the present invention, the health mattress may be used to provide a patient with heat or warm air through the mesh part 32 like a heater in winter, while supplying fresh and cool air to the patient through the mesh part 32 in summer.

1. A health mattress for household or medical use, comprising:
a lower cover integrally having a first edge part and a seating member which comes into contact with a human body;
an upper cover integrally having a second edge part and a mesh part which allows contaminants to pass through the same, wherein the upper cover is removably coupled to the lower cover by a separable attachment structure between the first edge part and the second edge part; and
a contaminant adhesion member interposed between the mesh part and the seating member in a state in which the lower cover and the upper cover are coupled, wherein the contaminant adhesion member has one or more adhesive sheets to which the contaminants having passed through the mesh part are adhered, and
wherein the mesh part includes: a first mesh fabric and a second mesh fabric facing each other while being coupled to an inner periphery of a third edge part; and an elastic yarn spring interposed between the first mesh fabric and the second mesh fabric, so as to form a gap elastically expanding or contracting between the first mesh fabric and the second mesh fabric.

2. The health mattress according to claim 1, wherein the contaminant adhesive member includes: a plurality of adhesive sheets, each having sticky surfaces on opposite sides thereof; an intermediate peel-off sheet interposed between upper and lower adjacent adhesive sheets; and a top peel-off sheet temporarily attached to a top surface of the uppermost adhesive sheet among the plural adhesive sheets, wherein a lowermost adhesive sheet among the plural adhesive sheets is adhered to a top surface of the seating member.

3. The health mattress according to claim 1, wherein the lower cover further includes a plurality of viscoelastic bosses formed on a bottom of the seating member and coming into close contact with a bed, a sofa or the floor of a floor-heated room.

4. The health mattress according to claim 2, wherein the intermediate peel-off sheet or the top peel-off sheet partially expands out of the edge of the adhesive sheet.
